(19) United States
(12) Patent Application Publication
(10) Pub. No.: US 2009/0258116 A1
(43) Pub. Date: Oct. 15, 2009

(54) Packaged food product and method of packaging and identifying packaged products

(76) Inventors: Arthur Peyton, Aurora, IL (US); Tammy Rice-Bailey, Lombard, IL (US); Susan Blanchard, Houston, TX (US); Arthur Nascimento, Chicago, IL (US)

Correspondence Address: RYNDAK & SURI LLP, 200 W. MADISON STREET, SUITE 2100, CHICAGO, IL, 60606, US

(21) Appl. No.: 12/082,631

(22) Filed: Apr. 11, 2008

(51) Int. Cl. G09F 3/10

(52) U.S. Cl. 426/87; 426/383

(57) ABSTRACT

The present invention relates to a custom-configured product and method of identifying packaged products and of distributing a packaged product. The method of labeling a product comprises creating a label which has an adhesive portion for adhering the label and indicia identifying a product; contacting the label adhesive with a first surface of the packaging, so that the label adheres to the surface; placing the product in the packaging, closing the packaging so that the indicia is visible to the customer examining the indicia to determine the destination for the product; and delivering the product to the destination. The labeled custom-configured product comprises: a custom-configured food product; a packaging containing the food product; the packaging having an interior surface and an exterior surface, where the interior surface is in contact with the food product; and a label having adhesive on a first face and indicia on a portion of a second face, the indicia identifying the food product, the adhesive adhering directly to the surface of the packaging, wherein the portion of the second face is visible outside the packaging so that a consumer can identify the food product from the indicia without opening the packaging.

### FIELD OF THE INVENTION

The present invention relates to a custom-configured product and method of identifying packaged products. It also relates to a method and apparatus of distributing a packaged product.

### BACKGROUND OF THE INVENTION

Quick serve restaurants must prepare a high volume of food relatively quickly. Hamburger sandwiches, cheeseburger sandwiches, sandwich wraps, coffees, teas and various types of sandwiches are common products that are served at many such restaurants, where a large volume of such items needs to be prepared relatively quickly. Since a high volume needs to be prepared quickly, labor requirements can be substantial, particularly for the high volume periods of breakfast, lunch, and dinner. Moreover, it is necessary for a general type of product, e.g., a hamburger sandwich, to be packaged in a generic-type of wrapper or container. Many customers order products with the ingredients standard to that product. However, with increasing frequency, customers are making special requests that ingredients be replaced, removed, or added. These special orders can add to the time required to produce the ordered food items. In addition, these special orders can create confusion and disruptions in the production area if they are not handled systematically and efficiently and also for customers, since the customer needs an indication of readily identifying special order food items, particularly where the customer receives multiple products.

A need exists for a system and method to keep track of special orders during processing in order to increase accuracy and speed. A need exists to give the employee a reference source to ensure the product is made according to a particular special order. Once the product is made, a need exists to inform the employee where to deliver the special order. Importantly, a need exists for the customer to accurately identify a special order product without opening the container and/or without tasting it, and to be able to distribute the products properly to people in a group.

A need exists for an efficient, reliable and attention grabbing method and system of providing such special order information in connection with the food products that are served to customers.

In a previous method, individual stickers connected the label to the packaging. In would be advantageous to remove the need for using a sticker to connect the label to the packaging. This would save time and materials, which both cost money. In addition, sticking the labels directly to the packaging allows for a more secure attachment. The products are often jostled around and stacked on top of each other, which can cause improperly secured labels to fall off. A label that falls off a product is useless, and can just add to the confusion.

### SUMMARY OF THE INVENTION

In accordance with the present invention, a packaged custom-configured food product is provided. The food product is packaged in a generic packaging containing the food product. The packaging has an interior surface and an exterior surface, where the interior surface may be in contact with the food product; and a two-sided label having adhesive on one side and human readable indicia on a portion of the other side, the indicia identifying the food product, and the adhesive for adhering the label directly to the surface of the packaging, wherein the indicia-bearing portion of the second side is visible outside the packaging and protrudes therefrom so that a consumer can readily identify the food product from the indicia without opening the packaging.

In accordance with another aspect of the invention, a method of labeling a product is provided. The method comprises creating a label which has on one side an adhesive portion for adhering the label and indicia on the other side identifying a product; contacting the label adhesive with the exterior surface of the packaging, so that the label adheres to the surface of the packaging; placing the product in the packaging, closing the packaging around the food product so that the indicia protrudes from the packaging to be readily visible to the customer holding or looking at the closed package and examining the indicia to determine the destination for the product.

In accordance with another aspect of the invention, a method of packaging a food product is provided. The method includes providing a label having two sides which has an adhesive on one side for adhering the label to packaging material for the food product and human recognizable indicia on a portion of the second side of the label for identifying the food product, contacting the label adhesive with a first surface of the packaging material so that the label adheres to the first surface of the packaging material, placing the food product in the packaging material, and closing the packaging material to form a package around the food product so that the portion of the label having the indicia protrudes from and is visible apart from the package.

In accordance with another aspect of the method, the method further includes providing a packaging wrapper, wherein the placing of the food product in the packaging includes placing the food product upside down on the wrapper, the wrapper having a plurality of edges and a second opposing surface. The method may further include closing the package by folding a first edge of the wrapper over the food product, wherein attaching the label to the packaging includes contacting the adhesive portion of the label against a first inside face of the wrapper so that the portion of the label having the indicia protrudes face up beyond and extends away from a second edge of the wrapper. In accordance with the method, closing the package can further comprise folding the second edge of the wrapper over the product and folding a third and fourth edge of the wrapper over the food product. The method may further include inverting the wrapper and the food product contained therein so that the indicia and food product are face up.

In accordance with another aspect of the invention, a carton may be provided as the packaging, with the carton having a top section and a bottom section, the bottom section having an inside face and an outside face, wherein the placing of the product in the packaging includes placing the product right-side up in the bottom section of the carton, attaching the label to the packaging includes contacting the adhesive portion of the label against an inside face of the carton and against an outside face of the carton, so that the indicia protrudes away from and beyond the outside face of the carton. This aspect may further include closing the packaging by folding a top section of the carton over the product so that the top section is in contact with the bottom section.

In accordance with another aspect of the method, the packaging may be composed of a cup and optionally a lid, wherein placing the product in the packaging comprises placing the product in the cup, wherein attaching the label to the packaging comprises contacting the adhesive portion of the label against an outside surface of the cup so that the label portion having the human recognizable indicia thereon protrudes from the cup.

In another embodiment, the method of packaging a food product includes providing a wrapper as the packaging, the wrapper having at least first and second opposed corners and outer and inner opposing faces, wherein the product is placed in the packaging by placing the product on the inner face of the wrapper and wherein closing the packaging further comprises folding the first corner of the wrapper over the product, wherein attaching the label to the packaging comprises contacting the adhesive portion of the label against the inner face of the wrapper at or adjacent the second corner opposed to the first corner so that the indicia protrudes beyond the second corner. The method further includes closing the packaging by folding the third and fourth corners of the wrapper over the product and may further include rolling the at least partially wrapped product toward the second corner of the wrapper.

In accordance with another aspect of the invention, the method further includes creating a label by feeding a label into a printer, the label having first and second faces, the adhesive portion on the first face of the label and printing the indicia on the second face of the label. The labels can be provided as label stock in the form of a roll that is fed into the printer where the indicia is printed onto the label stock. An index mark may be provided on the label roll for aligning the label roll in the printer based on the indexing of the index mark. Thereafter, the label roll is cut in the printer to create the label having the human readable indicia, wherein the label stock has a regularly spaced pattern of index marks along at least a portion of the length of the label roll.

In accordance with another aspect of the invention, a method of identifying a custom-configured food product is provided. The method includes creating a label which has an adhesive portion for adhering the label in human recognizable indicia identifying the custom-configured nature of the food product, attaching the label directly to the packaging for the food product so that the portion of the label having the indicia protrudes from and extends beyond the packaging, contacting the label adhesive in the surface of the packaging, so that the label adheres to the surface, containing the food product in the packaging so that the indicia on the label protrudes from and extends beyond the packaging, and examining the indicia to identify the nature of the custom-configured food product. The method may further include placing together a plurality of packaged food items in a location selected from a bag, a tray, a delivery service, a customer, a person for whom the customer ordered food, a counter in a food preparation area and then identifying the custom-configured food product by noting the protruding label and the information contained in the indicia.

In accordance with another aspect of the invention, a method of making a custom-configured packaged food product is provided. The method includes taking an order for a custom-configured food product, making the customized food product specified in the order, printing indicia on a first face of a label, the indicia identifying the custom configuration of the food product, the label having an adhesive coating on a second face, providing packaging for the food product, placing the food product on a surface of the packaging, contacting a label adhesive to a surface of the packaging so that the label adheres to the surface and protrudes from the packaging, enclosing the packaging around the food product so that the indicia remains protruding and extends away from the packaging.

In accordance with still another aspect of the invention, a packaged custom-ordered food product is provided. The packaged custom-ordered food product includes a specially configured food product, a generic packaging containing the food product, the packaging having an interior surface and an exterior surface, where the interior surface surrounds the food product. A two-sided label is provided having an adhesive on a portion of a first side and human recognizable indicia on a portion of a second side, the indicia identifying the custom order nature of the food product, the adhesive adhering directly to one of the surfaces of the packaging, wherein the portion of the second face having the indicia protrudes from and is visible outside the packaging so that a consumer can identify the custom order nature of the food product from the indicia independent of the packaging and without opening the packaging or tasting the food product. The label may comprise thermal paper and the indicia can be thermally printed thereon. In addition, the adhesive of the label can comprise first and second portions, a first portion may be in adhesive contact with the interior surface of the packaging and the second portion may be in adhesive contact with the exterior surface of the packaging. The packaging may be composed of a clamshell box or container. The adhesive may be present along only one edge of one side of a linerless paper label and may be present on less than about 30% of the linerless paper.

In another aspect, the indicia comprises a receipt. In addition, the label may be attached to the exterior surface of the packaging, along a single edge of the label. The packaged custom ordered food product may be contained in a carton, a wrapper, an envelope and a cup or other container, for example.

### BRIEF DESCRIPTION OF THE FIGURES

The accompanying drawings form part of the specification and like numerals are employed to designate like parts throughout the same.

FIG. 1A is a cross sectional view of an embodiment of a custom-configured food product being packaged in accordance with a method of the invention.

FIG. 1B is an enlarged fragmentary view of FIG. 1A;

FIG. 2 is a perspective view of FIG. 1.

FIG. 3 is a perspective view of FIG. 1 with the packaging closed.

FIG. 4 is a side elevational view of another embodiment of a custom-configured food product.

FIG. 5 is a perspective view of another embodiment of a custom-configured food product being packaged in accordance with a method of the invention.

FIG. 6 is a perspective view of the embodiment of FIG. 5 being prepared.

FIG. 7 is a perspective view of the embodiment of FIG. 5 with the packaging closed.

FIG. 8 is a top plan view of an embodiment of a custom-configured food product being packaged in accordance with a method of the invention.

FIG. 9 is a top plan view of the embodiment of FIG. 8.

FIG. 10 is a top plan view of the embodiment of FIG. 8 with the packaging closed.

FIG. 11 is a perspective view of an example of label stock useful in the practice of this invention.

FIG. 12 is a perspective view of a second example of label stock useful in the practice of this invention.

FIG. 13 is a perspective view of a third example of label stock useful in the practice of this invention.

FIG. 14 is a perspective view of a fourth example of label stock useful in the practice of this invention.

### DETAILED DESCRIPTION OF THE INVENTION

The present invention provides a labeled custom-configured food product, a method of labeling a food product, a method of distributing a product, and a method of making a customized and labeled food product. The labeled custom-configured food product and a method of labeling a food product will be discussed first. In one embodiment of this invention, a label 20 may be created by printing a human recognizable indicia 22 identifying a custom-configured food product on a label stock 26.

Indicia 22 can include any relevant information on the ordered custom-configured food product. For example, indicia 22 can communicate the relevant information via words, pictographs, diagrams, pictures, bar codes, numbers, symbols, punctuation and combinations thereof. Indicia 22 can have the following relevant information: a receipt, time made, time ordered, date made, date ordered, an identifier for the customer, an identifier for the person who took the order, price, method of payment, table number, customer name, customer phone number, customer address, customer vehicle license plate, company address, manager's name, other products ordered by the customer, or any combination thereof. Generally, the indicia will include a product identifier and product options such as ingredient substitutions, ingredient additions, and ingredient removals.

Custom-configured food product can be any type of food that is able to be customized. Custom-configured food product can be a sandwich, such as a hamburger sandwich, a submarine sandwich, a hoagie sandwich, a cheeseburger sandwich, a double hamburger sandwich, a double cheeseburger sandwich, a quarter-pound hamburger sandwich, a double quarter pound cheeseburger, a fish filet sandwich, fish patty sandwich, pork chop sandwich, pork patty sandwich, club sandwich, fried chicken sandwich, grilled chicken sandwich or chicken wrap sandwich, for example. Custom-configured food product can also be a liquid food product 32, any type of beverage, such as a milk shake, whole milk, skim milk, low fat milk, chocolate milk, apple juice, water, orange juice, carbonated beverages (e.g., cola, diet cola, lemon-lime), sports drinks, tea, coffee, iced tea, iced coffee, or flavored iced coffee, cappuccino, espresso, latte, espresso-based drinks or tea or combinations thereof, for example. Custom-configured food product can be pizza, candy, French fries, salad, chicken nuggets, parfait, cookies, cinnamon rolls, apple pie, sundaes, bowl of ice cream, ice cream cone, reduced fat ice cream, or caramel and apple, or combinations thereof.

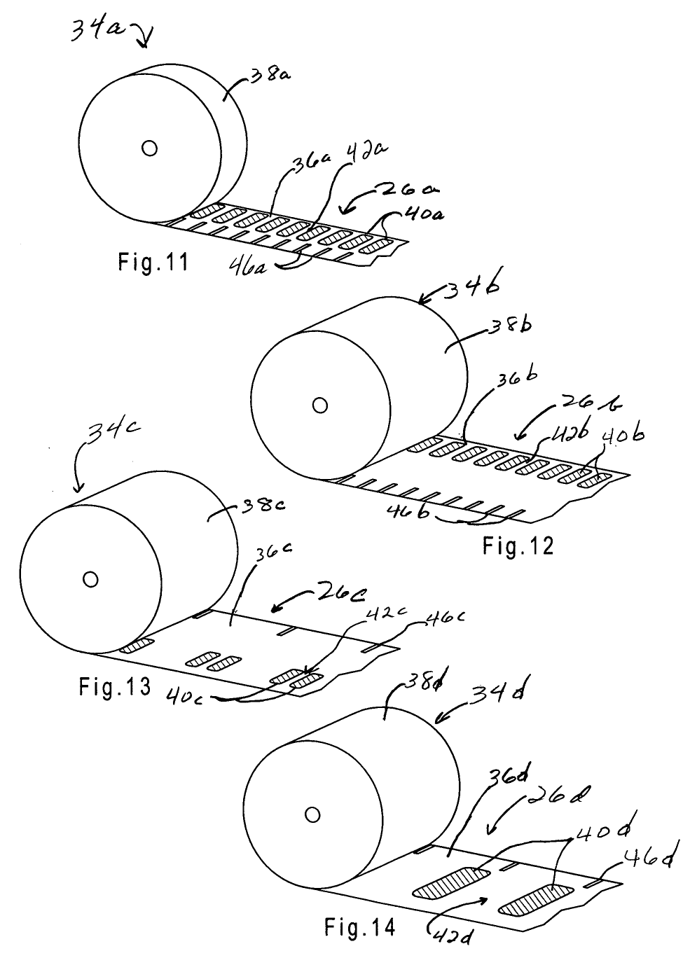

The label stock may be of any kind that is suitable for the invention. It may have one or more labels removably adhering to a sheet of release material (not illustrated). Specific embodiments of label stock in the form of a roll are shown in FIGS. 11-14. As illustrated in those figures, label stock 26a-d is in the form of a roll 34a-d. Label stock 26 has a first face 36a-d and a second face 38a-d. First face 36a-d has an adhesive coating. The adhesive coating (not shown) may coat the entire first face 36a-d. Preferably, the adhesive coating is provided as discontinuous patches 40a-d of adhesive coating separated by non-adhesive areas 42a-d. Patches 40a-d may be rectangular, rectangular with rounded corners, circular or oval, for example. With respect to the direction that label stock 26a-d is fed into a printer for printing indicia, patches may have convex leading (not shown) and trailing edges with substantially straight sides. Any kind of suitable adhesive may be used in the adhesive coating. Typically, the adhesive coating is a pressure sensitive adhesive. Preferably, the label stock has sufficient stiffness to enable labels made therefrom to readily protrude from the packaging in accordance with the invention.

Non-adhesive areas 42a-d generally extend across the width of rolls 34a-d. Typical widths are 40 and 80 mm. Non-adhesive areas 42a-d permit the cutting of label stock 26 into individual labels 20 without the printer cutter having to cut through adhesive patches, potentially gumming up the cutter. Non-adhesive areas 42a-d are distributed in a regular pattern relative to index marks 46a-d. Index marks 46a-d allow the label printer to index and align label stock 26a-d so that the label printer cuts through non-adhesive areas 42a-d.

Label stock 26a-d is typically made from paper, preferably thermal paper. Second face 38a-d has a release coating so that patches 40a-d on first face 36a-d do not permanently adhere to second face 38a-d in roll 34a-d. The release coating may cover the entire second face 38a-d. Alternatively the release coating may cover only the portion of second face 38a-d in registry with adhesive patches 40a-d. Typically, indicia is printed on second face 38a-d.

Creating a label can include indexing an index mark and aligning label stock, printing indicia on label stock, preferably thermally, and cutting stock through a non-adhesive area. The cut may fully separate label 20 from roll 34 or it may leave a small portion of the width uncut for later tearing by a human operator, for example.

The label is then pressed against a first surface of product packaging such that the adhesive coating holds the label to the surface of the packaging. Custom-configured food product identified by a label is placed inside suitable packaging. Next the packaging is closed or wrapped so that the indicia portion of the label protrudes from and is visible to the customer.

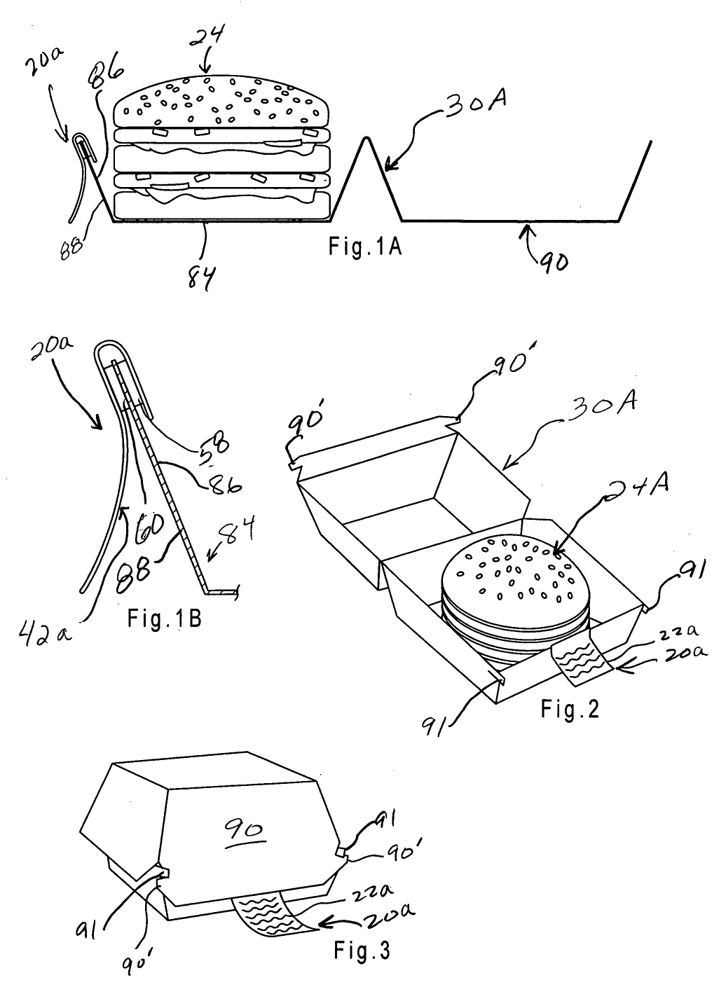

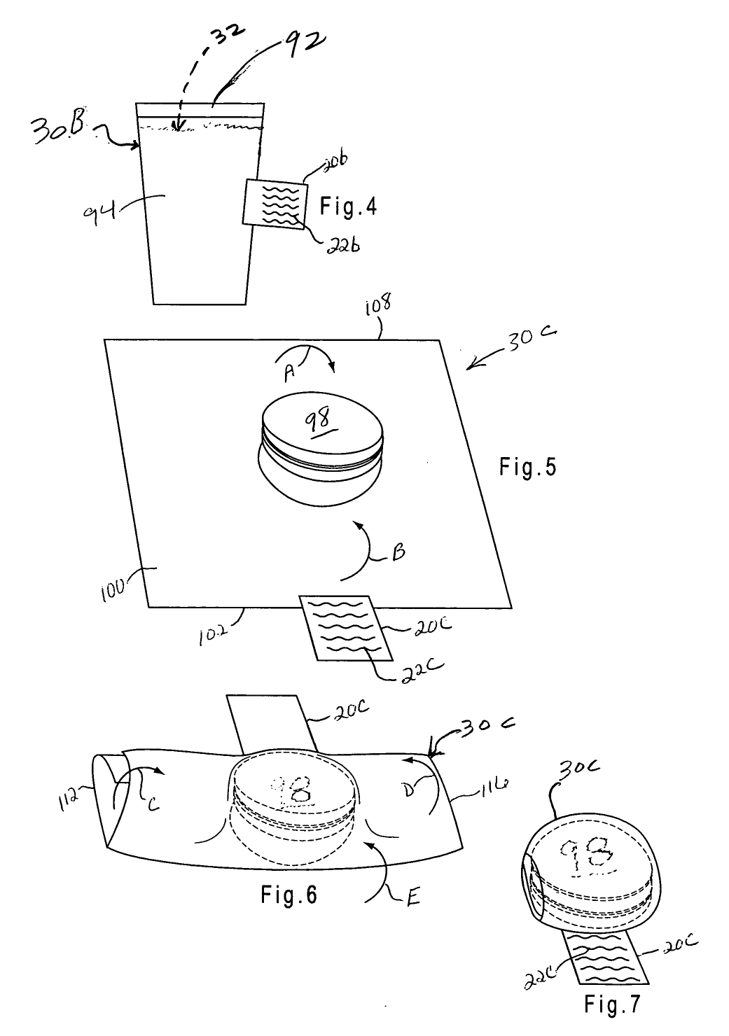

Packaging 30A-D is respectively a clamshell box 30A (FIGS. 1-3), a cup 30B (FIG. 4), wrapper 30C-D (FIGS. 5, 6, 8 and 9). Typically, labels 20a-d and packaging 30A-D are arranged such that indicia 22a-d on labels 20a-d are able to be read. Labels 20a-d and packaging 30A-D are also arranged so that labels 20a-d noticeably and substantially protrude from packaging 30A-D (FIGS. 3, 4, 7 and 10). In this manner, the attention of a consumer is directed to the protruding label. The examples below show how packaging 30A-D can be wrapped for a few sample custom-configured products 24, 32, 98 and 118. Types of packaging 30A-D, the manner of closing packaging 30A-D, and locations for adhering labels 20a-d so that they are readily visible are described in greater detail hereafter.

In another aspect of the invention, a method of packaging custom-configured food product is provided. First, a label is created that has an adhesive portion and indicia. The indicia identify the product and optionally the product's destination. The identification includes whatever special requests the customer made for the custom-configured food product, as discussed previously. For example, the indicia could indicate a cheeseburger was ordered without ketchup or onions, for example. The destination indicates where the food product should go after it is assembled. The label is then attached directly to the packaging for the product the indicia identify. The packaging can be anything that is suitable for enclosing and protecting the food product identified on the indicia. The food product is then enclosed in the packaging, while leaving the indicia protruding from packaging 30 and readily visible to the customer. Finally, the indicia can be examined to determine the nature of the custom-configured product and/or its destination, and then the packaged and labeled food product is delivered to that destination.

Preferably, the identification is facilitated by having the indicia able to be easily recognized and read after the packaging has been closed around the custom-configured food product. The protruding nature of the indicia bearing portion of the label greatly facilitates accomplishing the identification of the custom nature of the food product. The destination indicated by the indicia could be to deliver it to a specific named employee, an employee specified by location (e.g., at a particular cash register), a particular bag, a particular tray, a named delivery service, a customer identified by name or receipt number, a particular table number, a person for whom the customer ordered food, a particular counter, or a specific food preparation area.

The invention can optionally include delivering the custom-configured food products to the destination indicated by indicia as discussed above. Having viewed indicia for a destination, the employee delivers the custom-configured food product to the correct person or area. For example, all of the custom-configured food products of one order could be directed to a particular bag or tray. Once on the tray or in the bag it can be handed directly to the customer though a drive-through window or across a counter. If the custom-configured food product is a single order of coffee, the indicia could have a receipt for the customer and provide the name of a customer. The custom-configured food product could also be hand delivered to the cashier who took the order indicated on the label. The cashier can then put it on the correct tray or in the correct bag.

Typically, as seen in the individual examples below, the labels are printed on larger label stock, which can be 40 mm or 80 mm wide. The larger labels allow for more indicia or larger print to be put on the labels, which makes them easier to read. The larger labels also have room for more adhesive, so the label can be attached to packaging more securely. However, the larger label stock costs more, because larger label stock uses more paper and more adhesive coating. Smaller 40 mm label stock can be used for a cup-type container, for example, because the cups do not have as much spare surface area as other packaging.

In another embodiment, a method of making a custom-configured and labeled food product is provided. First, an order for a custom-configured food product is taken. The order may specify, for example, a “Big Mac®” hamburger sandwich without pickle. Ordered custom-configured food product is then made without pickle. Indicia is printed on a first face of a label. The indicia identifies the ordered food product. The indicia may state “Big Mac®—no pickle,” for example. The indicia may provide other information as discussed earlier. The label may be obtained from a label roll as discussed earlier. The label has an adhesive coating on its second face. Packaging is provided for the food product. Packaging can be any suitable packaging as discussed earlier, placing the food product on a surface of the packaging. The label is made to adhere to a surface of packaging by contacting the label adhesive to the surface of packaging. Finally the packaging is closed so that the indicia protrudes from the packaging and is visible to the customer.

Referring to FIGS. 1A, 1B and 2, packaging 30A is a clamshell carton and a custom-configured food product 24 can be a Big Mac® hamburger sandwich. As seen in FIG. 1, label 20a, from label roll 34a shown in FIG. 13, protrudes away from packaging 30A to provide a distinct visual cue to a customer. In this manner, the customer can readily identify the nature of the custom-configured sandwich. Label 20a has two separate and distinct adhesive portions 58 and 60. Label 20a is applied to a bottom section 84 of carton 30A so that adhesive portion 58 adheres to an interior surface 86 of bottom section 84 and adhesive portion 60 adheres to an exterior surface 88 of bottom section 84. Before or after label 20a is applied to bottom section 84, the hamburger sandwich 24 is placed in bottom section 84. Hamburger sandwich 24 is made according to indicia 22a on label 20a. For example, the indicia 22a may indicate to add, remove or include extra cheese, lettuce, tomato slices, mayonnaise, ketchup, onion, pickle or mustard, for example. As shown in FIG. 3, a top section 90 of carton 30A is closed by the engagement of top carton clasps 90′ with bottom carton clasps 91.

Label 20a has a large non-adhesive area 42a. Non-adhesive area 42a allows label 20a to not adhere to carton 30A at area 42a and to flare away and protrude from carton 30A. As such label 20a protrudes from carton 30A and quickly grabs the attention of a customer. Protruding label 20a makes it easier for a customer to identify different sandwiches which is very advantageous when several sandwiches are ordered in a single order. Similarly, a functionally comparable label may be obtained from label roll 34b illustrated in FIG. 11.

As seen in FIG. 4, packaging 30B can be a cup for holding a liquid food product 32. Liquid food product 32 is typically tea or coffee. Label 20b is created from label roll 34a shown in FIG. 11. Label roll 34a can have a width of 40 mm. Label 20b may have two adhesive portions 40a and two index marks 46a as shown in FIG. 11. By having relatively short non-adhesive areas 42a, label roll 34a can be used to create labels 20 of various lengths depending on the amount of indicia 22b to be printed, with little waste.

Label 20b for cup 30B has adhesive portions 40a as shown in FIG. 11 adhering to the exterior surface 94 of cup 30B. Preferably, label 20b is affixed to cup 30B so that label 20b protrudes from cup 30B like a flag as seen in FIG. 4. Before or after label 20b is affixed, liquid food product 32 is placed in cup 30B. Liquid food product 32 is made according to indicia 22b on label 20b. A lid 92 covers cup 30B.

As seen in FIGS. 5-7, packaging 30C can be a wrapper and the food can be a single hamburger sandwich 98. Label 20c for wrapper 30C has an adhesive portion (not shown) near its top adhering to interior surface 100 of wrapper 30C. Label 20c may be obtained from any of rolls 34a-d. Label 20c protrudes well beyond a first edge 102 so that indicia 22c will be visible. Before or after label 20c is affixed, single hamburger sandwich 98, made according to indicia 22c, is placed upside down substantially in the middle of wrapper 30C (FIG. 5). As seen in FIG. 5, a first fold in the direction of arrow A is made folding the second edge 108 of wrapper 30C over single hamburger sandwich 98 towards label 20C. The second fold indicated in the direction of arrow B is made folding first edge 102 of wrapper 30C over single hamburger sandwich 98. After folds A and B, hamburger sandwich 98 is illustrated in FIG. 6. As seen in FIG. 6, folds in the direction of arrows C and D can be performed in any order. Fold C folds a third edge 112 of wrapper 30C over single hamburger sandwich 98. Fold D folds a fourth edge 116 of wrapper 30C over single hamburger sandwich 98. Finally, the upside down, wrapped single hamburger 98 is turned over 180 degrees as shown by inversion E. Thus, single hamburger 98 ends up packaged with label 20c protruding from wrapper 30C with indicia 22c facing up for prompt visual identification as seen in FIG. 7.

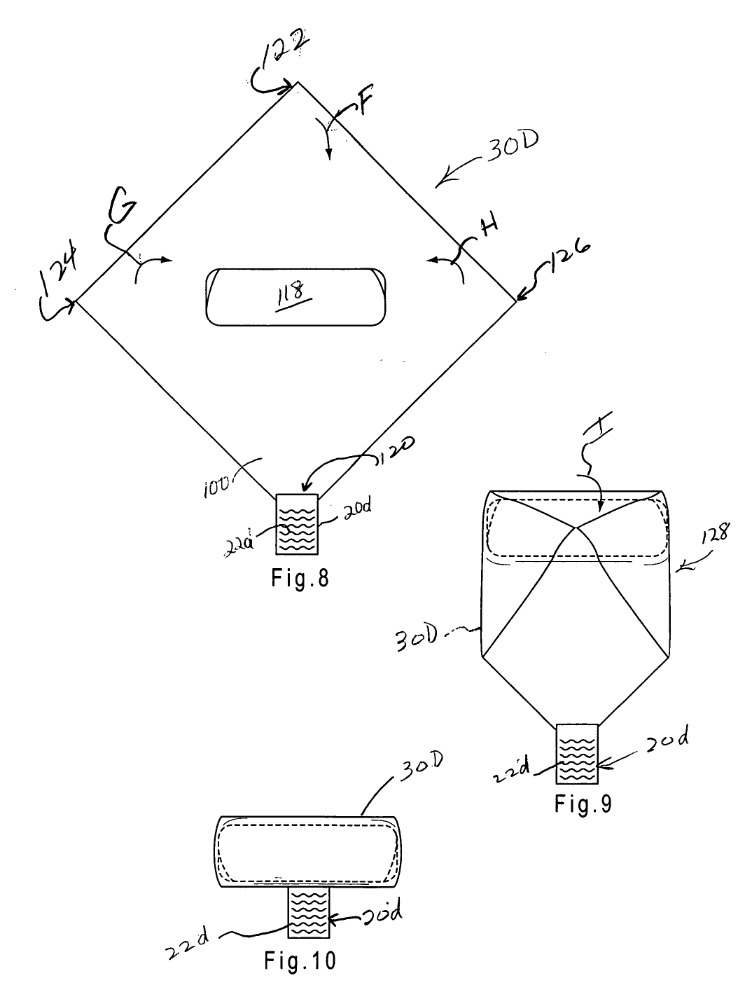

As seen in FIGS. 8-10, packaging 30D can be a wrapper and the food can be a burrito 118 or other wrap-type of food product. Label 20d for wrapper 30D has an adhesive portion (not shown) near its top adhering to interior surface 100 of wrapper 30D. Label 20d may be obtained from any of rolls 34a-d. Label 20d protrudes over a first corner 120 so that indicia 22d will be visible extending beyond wrapper 30D. Before or after label 20d is affixed, burrito 118, specially configured to conform to indicia 22d, is placed on wrapper 30D. As used herein, placing in a package includes placing on a wrapper. As seen in FIG. 8, three folds F, G and H are made. Folds F, G and H can be performed in any order although performing fold F first is preferred. Fold F folds a corner 122, opposite or substantially opposite to corner 120, over burrito 118. Folds G and H fold corners 124 and 126 over burrito 118 thereby forming a pouch 128. Pouch 128 is rolled towards label 20d as shown by arrow I in FIG. 9 until the wrapper is fully rolled as shown in FIG. 10. Thus, label 20d protrudes from the packaging in such a way that it draws attention to itself and indicia 22d thereon.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims.

1. A method of packaging a food product, comprising:
providing a label having two sides which has an adhesive on one side for adhering the label to packaging material for the food product and human recognizable indicia on a portion of the second side of the label for identifying the food product;
contacting the label adhesive with a first surface of the packaging, so that the label adheres to the surface of the packaging material;
placing the food product in the packaging material; and
closing the packaging material to form a package around the food product so that the portion of the label having the indicia protrudes from and is visible apart from the package.

2. The method of claim 1 further comprising:
providing a packaging wrapper, wherein placing the food product in the packaging comprises placing the food product upside down on the wrapper, the wrapper having a plurality of edges and a second opposing surface.

3. The method of claim 2 wherein closing the packaging further comprises:
folding a first edge of the wrapper over the food product, wherein attaching the label to the packaging comprises contacting the adhesive portion of the label against a first inside face of the wrapper so that the portion of the label having the indicia protrudes face up beyond and extends away from a second edge of the wrapper.

4. The method of claim 3 wherein closing the packaging further comprises:
folding the second edge of the wrapper over the food product.

5. The method of claim 4 wherein closing the packaging further comprises:
folding a third and fourth edge of the wrapper over the food product.

6. The method of claim 5 further comprising inverting the wrapper and food product contained therein so that the indicia and food product are face up.

7. The method of claim 1 further comprising:
providing a carton as the packaging, the carton having a top section, a bottom section, the bottom section having an inside face and an outside face, wherein placing the product in the packaging comprises placing the product right-side up in the bottom section of the carton.

8. The method of claim 7 wherein attaching the label to the packaging comprises contacting the adhesive portion of the label against an inside face of the carton and against an outside face of the carton, so that the indicia protrudes away from and beyond the outside face of the carton.

9. The method of claim 7 wherein closing the packaging comprises folding a top section of the carton over the product so the top section is in contact with the bottom section.

10. The method of claim 1 further comprising:
providing a cup as the packaging, wherein placing the product in the packaging comprises placing the product in a cup, wherein attaching the label to the packaging comprises contacting the adhesive portion of the label against an outside surface of the cup.

11. The method of claim 1 further comprising:
providing a wrapper as the packaging, the wrapper having at least first and second opposed corners and outer and inner opposing faces, wherein placing the product in the packaging comprises placing the product on the inner face of the wrapper.

12. The method of claim 11 wherein closing the packaging further comprises:
folding the first corner of the wrapper over the product, wherein attaching the label to the packaging comprises contacting the adhesive portion of the label against the inner face of the wrapper at or adjacent the second corner opposed to the first corner so that the indicia protrudes beyond the second corner.

13. The method of claim 12 wherein closing the packaging further comprises:
folding third and fourth corners of the wrapper over the product to at least partially wrap the product.

14. The method of claim 13 wherein closing the packaging further comprises:
rolling the at least partially wrapped product toward the second corner of the wrapper.

15. The method of claim 1 wherein creating a label comprises feeding a label into a printer, the label having first and second faces, the adhesive portion on the first face of the label; and printing indicia on the second face of the label.

16. The method of claim 1 wherein creating a label comprises providing label stock in a roll and feeding the label stock into a printer.

17. The method of claim 16 wherein creating a label further comprises printing the indicia onto the label stock.

18. The method of claim 17 wherein creating a label further comprises:
indexing an index mark on the label roll for aligning the label roll in a printer;
aligning the label roll in the printer based on the indexing of the index mark; and
cutting the label roll in the printer to create the label having the indicia, wherein the label stock has a regularly spaced pattern of index marks along at least a portion of the length of the label roll.

19. The method of claim 1 further comprising providing a product having a custom configuration, the indicia identifying the custom configuration.

20. A method of identifying a custom-configured food product, comprising:
creating a label which has an adhesive portion for adhering the label, and human recognizable indicia identifying the custom-configured food product;
attaching the label directly to the packaging for the food product so that the portion of the label having the indicia protrudes from and extends beyond the packaging;
contacting the label adhesive and a surface of the packaging, so that the label adheres to the surface;
containing the food product in the packaging so that the indicia on the label protrudes from and extends beyond the packaging; and
examining the indicia to identify the nature of the custom-configured food product.

21. The method of claim 20, further comprising placing together a plurality of packaged food items in a location selected from the group consisting of a bag, a tray, a delivery service, a customer, a person for whom the customer ordered food, a counter and a food preparation area;
identifying the custom-configured food product by noting the protruding label and the information contained in the indicia.

22. A method of making a custom-configured packaged food product, comprising:
taking an order for a custom-configured food product;
making the custom-configured food product specified in the order;
printing indicia on a first face of a label, the indicia identifying the custom configuration of the food product, the label having an adhesive coating on a second face;
providing packaging for the food product;
placing the food product on a surface of the packaging;
contacting the label adhesive to a surface of the packaging, so that the label adheres to the surface and protrudes from the packaging; and
closing the packaging around the food product so that the indicia remains protruding and extending away from the packaging.

23. A packaged custom-configured food product, comprising:
a specially configured food product;
a generic packaging containing the food product; the packaging having an interior surface and an exterior surface, where the interior surface surrounds the food product;
a two-sided label having an adhesive on a portion of a first side and human recognizable indicia on a portion of a second side, the indicia identifying the custom order nature of the food product, the adhesive adhering directly to one of the surfaces of the packaging, wherein the portion of the second side having the indicia protrudes from and is visible outside the packaging so that a consumer can identify the custom order nature of the food product from the indicia independent of the packaging and without opening the packaging or tasting the food product.

24. The packaged custom-configured food product of claim 23, wherein the label comprises thermal paper and the indicia is thermally printed.

25. The packaged custom-configured food product of claim 23, wherein the adhesive of the label comprises first and second portions, the first portion in adhesive contact with the interior surface of the packaging and the second portion in adhesive contact with the exterior surface of the packaging.

26. The packaged custom-configured food product of claim 25, wherein the packaging comprises a clamshell box.

27. The packaged custom-configured food product of claim 26, wherein the adhesive is only present along one edge of a linerless paper label.

28. The packaged custom-configured food product of claim 26, wherein the adhesive coating is present on less than 30% of the linerless paper.

29. The packaged custom-configured food product of claim 23, wherein the indicia comprises a receipt.

30. The packaged custom-configured food product of claim 23, wherein the label is attached to the exterior surface of the packaging along a single edge of the label.

31. The packaged custom-configured food product of claim 23, wherein the packaging is selected from the group consisting of a carton, a wrapper, an envelope, and a cup.
